(19) United States
(12) Patent Application Publication
(10) Pub. No.: US 2024/0027707 A1
(43) Pub. Date: Jan. 25, 2024

(54) SEALING TRANSCEIVER-FIBEROPTICAL INTERFACES

(71) Applicant: RF Scientific, LLC, Austin, TX (US)

(72) Inventors: Nathan Bosch, Austin, TX (US); Robert Sparks, Burnet, TX (US); Daniel Hogberg, Austin, TX (US)

(73) Assignee: RF Scientific, LLC, Austin, TX (US)

(21) Appl. No.: 17/871,356

(22) Filed: Jul. 22, 2022

(51) Int. Cl. G02B 6/42; B29D 11/00; B33Y 80/00

(52) U.S. Cl. CPC G02B 6/4253; G02B 6/4246; B29D 11/0075; B33Y 80/00; B29K 2063/00

(57) ABSTRACT

Advanced computing applications have evolved to include servers submersed in dielectric oils to provide efficient cooling. Transceiver-fiber optic cable interface assemblies that support data communications may not be sealed adequately to be submersed, and require sealing before they can be used in such applications. A mold may be three dimensionally (3D) printed or additively manufactured (AM) and used to form a sealing material around the assembly to provide such protection.

### TECHNICAL FIELD

The invention generally relates to optical cables interfaced with electronics and, more particularly, to protecting and sealing interfaced transceiver-active fiber optical cables for use in network systems requiring submersion in cooling environments.

### BACKGROUND

Active fiber optical cables or optical fibers typically are available in two varieties: (1) an optical cable integrated into a transceiver; and (2) a mated combination of a transceiver and an optical cable. These systems are often used in advanced computing applications supporting data communications. Such applications have evolved in many instances to include servers submersed in cooling liquids, for example, dielectric oils, to provide efficient cooling. These transceiver-active fiber optical cable interfaces, however, may not be properly and protectively sealed for submersion in the cooling liquids and performance may be degraded. Moreover, there are not many submersible system providers for networking equipment. Finisar and Dell, for example, have all pursued the concept with limited success. Historically, this included using a Direct Attached Copper (DAC) cable to exit the submersible components, and then use a conversion to optical cable.

### SUMMARY

A three dimensional (3D) printed mold, such as a potting mold, and associated methods may be used for protecting and sealing transceiver-active fiber optical cable interfaces for submersion in liquids, such as cooling liquids, in accordance with exemplary embodiments of the present disclosure. Such transceiver-active fiber optical cables may be used as sub-components in networking systems, high performance computing applications, high end telecommunications applications, and data centers. The systems and methods disclosed herein for sealing and protecting may provide solutions or improvements for active fiber optical cables, including for custom active fiber optical cables. For example, the systems and methods may allow for sealed direct connections between electronics and optical infrastructure that may be submersed completely in cooling liquids along with the electronic networking component(s) or unit(s) (e.g., a network switch for a data center) requiring such submersion. These systems and methods advantageously do not require the conventional use of a patch panel outside the cooling liquid for optical/electronic (e.g., copper) conversion interfaces because prior fiber optical interfaces could not be submersed. Thus, hardware costs may be reduced.

The types of active fiber optical cables or optical fibers may be an optical cable integrated into a transceiver or a mated combination of a transceiver and an optical cable. Components involved with these systems and methods may include optical transceivers, active fiber optical cables, epoxy or other adhesives, room temperature (RTV) cooling oils, or other cooling liquids, and a potting mold that may be procured or created or manufactured by 3D printing, additive manufacturing (AM), or other techniques.

Other systems, methods, features, and advantages of the present disclosure will be or become apparent to one of skill in the art upon examination of the following drawings and detailed description. It is intended that all such additional systems, methods, features, and advantages are included within this description, are within the scope of the present disclosure, and are protected by the accompanying claims.

### BRIEF DESCRIPTION OF THE DRAWINGS

Aspects of the present disclosure may be better understood with reference to the following drawings, emphasis being placed upon clearly illustrating the principles of the present disclosure.

FIG. 1 is a perspective view illustrating a mold, such as a potting mold, in process of being positioned with a transceiver-fiber optical cable interface assembly, in accordance with exemplary embodiments of the present disclosure;

FIG. 2 is a perspective view illustrating a mold as it is positioned around or on a transceiver-fiber optical cable assembly and a nozzle for introducing a sealing material into the potting mold;

FIG. 3 is a perspective view illustrating filling a mold with a sealing material from the nozzle;

FIG. 4 is a perspective view schematically illustrating a mold being removed from being positioned with the transceiver-fiber optical cable interface assembly after hardening or curing of the sealing material;

FIG. 5 is a plan view schematically illustrating an arrangement or plurality of sealed transceiver-fiber optical cable interface assemblies submersed in a cooling liquid in which details of a network component(s) the assemblies are used with are not shown (i.e., the assemblies and network component(s) typically would be completely submersed together in the cooling liquid);

FIG. 6 is a front-end view illustrating an arrangement of a mold and a fiber connector end of a transceiver-fiber optical cable interface assembly, showing the fiber in cross-section, in process of the mold being positioned with the interface assembly;

FIG. 7 is a rear-end view illustrating a mold and a transceiver connector end of a transceiver-fiber optical cable interface assembly, in process of the mold being positioned with the interface assembly, and also showing a sectioning for the view in FIG. 8; and

FIG. 8 is a side cross-sectional view illustrating a mold, according to the sectioning in FIG. 7, and a side elevational view illustrating a transceiver-fiber optical cable interface assembly, in process of the mold being positioned with the interface.

### DETAILED DESCRIPTION

In the description that follows, like parts are marked throughout the description and drawings with the same reference numerals. The drawings and components in the drawings might not be to scale and certain components may be shown in generalized or schematic form and may be identified by commercial designations in the interest of clarity and conciseness.

As used herein, the singular forms “a”, “an”, and “the” are intended to include the plural forms as well, unless the context clearly indicates otherwise. It should be further understood that the terms “comprise” and/or “comprising,” if used herein, specify the presence of stated features, integers, steps, operations, elements, components, and/or groups thereof, but do not preclude the presence or addition of one or more other features, integers, steps, operations, elements, components, and/or groups thereof. If used herein, the term “and/or” includes any and all combinations of one or more of the associated listed items.

Using a mold, such as a potting mold, active fiber optical cables, including custom-designed active fiber optical cables, and connector components, and their interfaces with transceivers and their corresponding connector components, may be sealed and protected with adhesive materials, in accordance with exemplary embodiments of the present disclosure. The adhesive materials may be an epoxy or the like and provide a conformal coating(s). Other possible conformal coating or potting materials may be acrylic- or silicone-based. The finished transceiver-active fiber optical cable assemblies and their optical interfaces may be fully submersible in, and effectively sealed from, a cooling liquid, such as room temperature non-reactive (RTV) silicone, oil, or other cooling liquids. The mold may be procured or 3D-printed or additive manufactured (AM) and may be flexible and unique to the particular transceiver's footprint and optical cable. The mold or portions of the mold may alternatively be created or manufactured using other techniques, such as by injection molding, milling and/or drilling techniques, and/or the like.

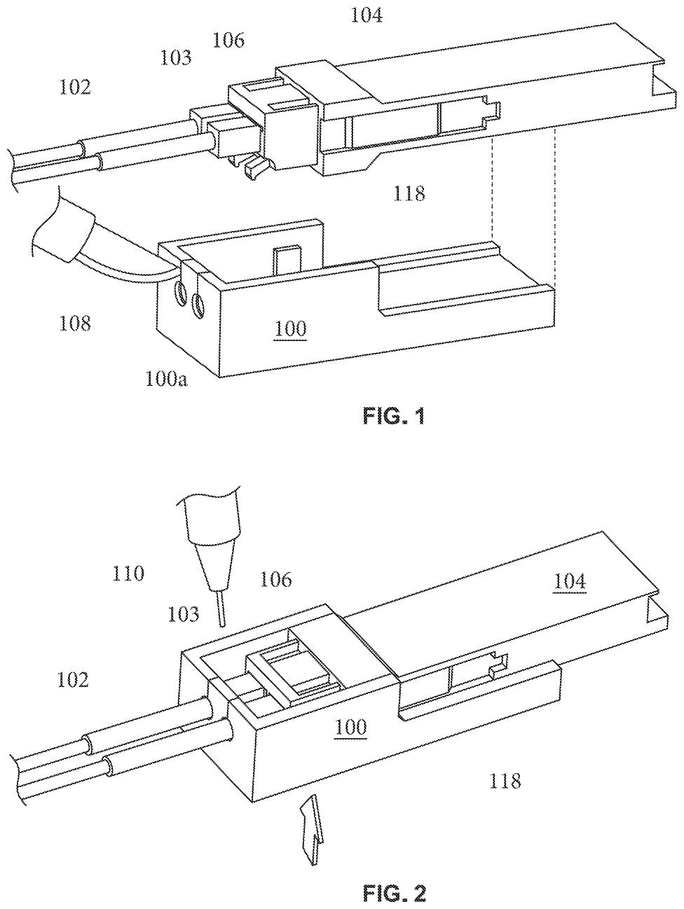

FIG. 1 is a perspective view illustrating a mold 100 in process of being positioned with a transceiver-fiber optical cable interface assembly 104, in accordance with exemplary embodiments of the present disclosure. The interface assembly 104 includes its own latching mechanism 118 and a transceiver coupler or connector 106. The interface assembly 104 couples or connects a fiber optical cable 102, such as an active fiber optic cable, using a fiber optic coupler(s) or connector(s) 103, to the corresponding transceiver coupler or connector 106, such that light signals may pass in one direction to be converted into electrical or electronic signals in the transceiver (not shown) within the assembly 104, which also is coupled or connected to the transceiver coupler 106. Also, electrical or electronic signals in the transceiver may be converted into light signals that travel in the fiber optical cable 102 in the opposite direction. The mold 100 may include a slotted opening(s) 100a that fits over the fiber optical cable 102, for example, with the aid of a tool 108, such as a knife, blade, or the like, to help facilitate positioning of the potting mold 100 around or on the interface assembly 104.

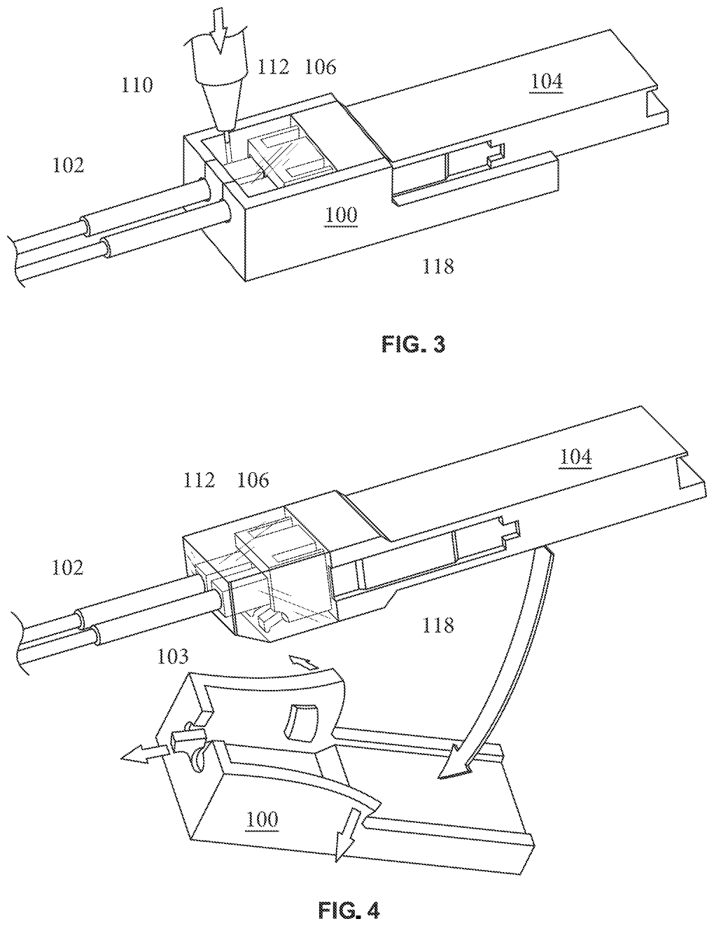

FIG. 2 is a perspective view illustrating the mold 100 as it is positioned around, over, or on the transceiver-fiber optical cable assembly 104 and also illustrates a nozzle 110 for introducing a sealing material 112 (see FIG. 3) into the potting mold 100.

FIG. 3 is a perspective view that illustrates filling the potting mold 100 with the sealing material 112 from the nozzle 110.

FIG. 4 is a perspective view schematically illustrating the mold 100 being removed from the transceiver-fiber optical cable interface assembly 104 after hardening or curing (e.g., by outgassing or off gassing) of the sealing material 112. The sealing material may harden over time, such as by room temperature curing, or it may be hardened or cured by application of heat or light radiation, such as ultraviolet, visible, or infrared light. Moreover, the mold 100 may be reused for sealing other assemblies 104 upon cleaning any remaining sealing material 112 residue from the mold 100.

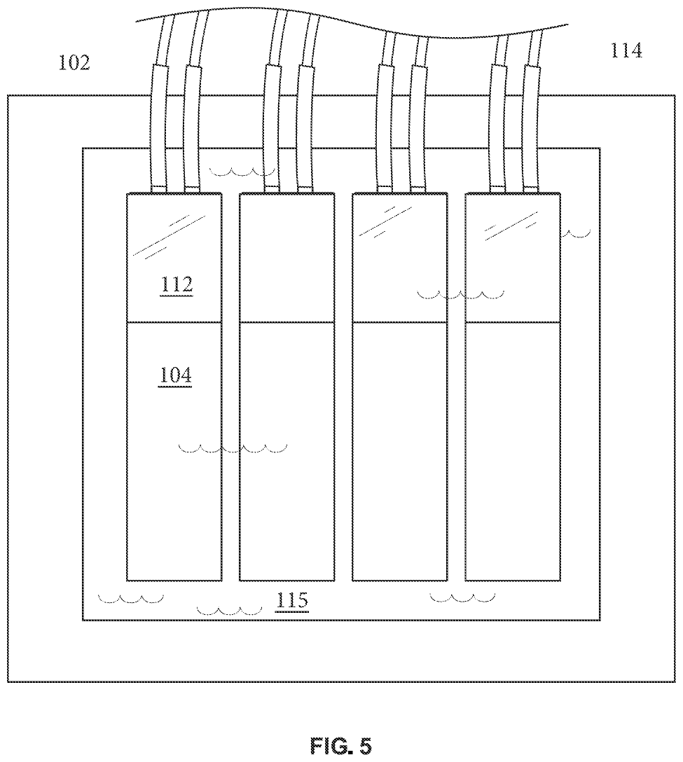

FIG. 5 is a plan view schematically illustrating an arrangement or plurality 114 of sealed transceiver-fiber optical cable interface assemblies 104 submersed in a cooling liquid 115 along with a network component(s), unit(s), or hardware into which the transceivers would be inserted, the details of the network component(s) being omitted for clarity The assemblies and the network component(s) typically would be completely submersed in the cooling liquid).

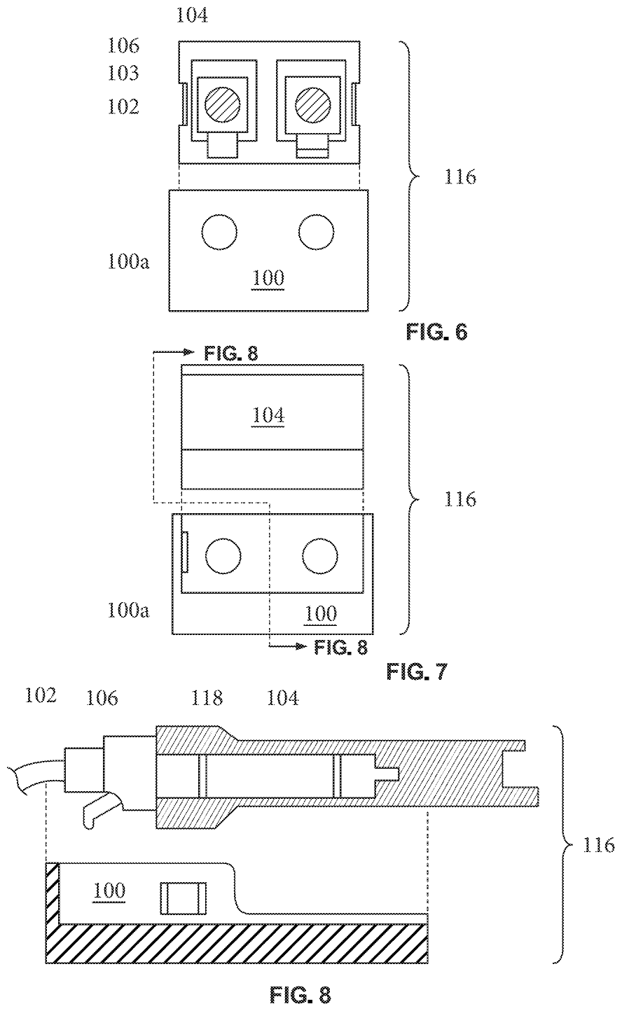

FIG. 6 is a front-end view illustrating an arrangement 116 of the mold 100 and the fiber optic connector 103 coupled to the transceiver coupler 106 with the fiber optical cable 102 in cross-section, in process of the mold 100 being positioned with, over, or on the transceiver-fiber optical cable interface 104 and before the sealing material is introduced into the mold 100.

FIG. 7 is a rear-end view illustrating the arrangement 116 of the mold 100 and the interface assembly 104, in process of the mold 100 being positioned with, over, or on the interface assembly 104, before the sealing material is introduced into the mold 100, and also showing a sectioning for the view in FIG. 8.

FIG. 8 is a side cross-sectional view illustrating the arrangement 116 of the mold 100, according to the sectioning in FIG. 7, and a side elevational view illustrating the interface assembly 104, in process of the mold 100 being positioned with, over, or on the interface assembly 104, and before the sealing material is introduced into the mold 100.

The specific embodiments disclosed herein are merely exemplary. Many variations, modifications, equivalents, and/or alternatives may be made to or from those embodiments, and such variations, modifications, equivalents, and/or alternatives may be practiced in a manner or manners other than those specifically described herein without departing from the principles, spirit, and scope of the present disclosure. Specifically, it should be understood that the appended claims are not intended to be limited to those particular embodiments or forms disclosed, but rather also to cover all such variations, modifications, equivalents, and/or alternatives. Furthermore, any structures, components, apparatus, process, and/or method parameters, and/or sequences of steps disclosed and/or illustrated herein are given by way of example only and may be varied as desired unless specifically stated otherwise. For example, for any steps illustrated and/or described herein that are shown or discussed in a particular order, these steps do not necessarily need to be performed in the order illustrated or discussed. Moreover, the various exemplary structures, components, apparatus, processes, or methods described and/or illustrated herein may also omit one or more certain structures, components, apparatus, processes, methods, or steps described and/or illustrated herein or include additional structures, components, apparatus, methods, and/or steps in addition to those disclosed.

1. A method of sealing a transceiver-fiber optical cable interface assembly for submersion in a cooling liquid, comprising:
procuring a 3D printed or additive manufactured mold;
positioning the mold with, over, or on a transceiver-fiber optical cable interface assembly;
filling open space within the mold with a sealing material;
curing the sealing material.

2. The method of claim 1, further comprising removing the mold from the assembly.

3. The method of claim 1, wherein the mold comprises a potting mold.

4. The method of claim 1, wherein the sealing material comprises an adhesive.

5. The method of claim 4, wherein adhesive comprises epoxy.

6. The method of claim 1, further comprising sealing the assembly with the sealing material.

7. The method of claim 1, wherein the positioning the mold comprises positioning the mold with the aid of a tool.

8. The method of claim 1, wherein the mold comprises a slotted opening.

9. The method of claim 1, further comprising, after removing the mold, placing the assembly in a cooling liquid.

10. The method of claim 9, wherein the cooling liquid comprises an oil.

11. The method of claim 9, wherein the cooling liquid comprises RTV silicone.

12. The method of claim 1, further comprising reusing the mold with another assembly.

13. The method of claim 1, wherein the mold comprises a flexible mold.

14. The method of claim 1, wherein the transceiver-fiber optical cable interface assembly comprises a transceiver-active fiber optical cable interface assembly.

15. The method of claim 1, further comprising submersing the assembly in a cooling liquid.

16. The method of claim 1, wherein the transceiver-fiber optical cable interface assembly is configured as a sub-component in a networking system, a high-performance computing application, a high-end telecommunications application, or a data center.

17. The method of claim 1, further comprising, after removing the mold, submersing the assembly with other such assemblies in a cooling liquid.

18. The method of claim 1, wherein the procuring the mold comprises manufacturing the mold to a particular transceiver's footprint and optical cable.

19. The method of claim 1, wherein the filling with the sealing material comprises filling the sealing material from a nozzle.

20. The method of claim 1, wherein the assembly comprises an optical cable integrated into a transceiver.

21. The method of claim 1, wherein the assembly comprises a mated combination of a transceiver and an optical cable.

22. A method of sealing a transceiver-fiber optical cable interface assembly for submersion in a cooling liquid, comprising:
positioning a manufactured mold with, over, or on a transceiver-fiber optical cable interface assembly;
filling open space within the mold with a sealing material;
curing the sealing material; and
removing the mold from the assembly.

23. The method of claim 22, further comprising manufacturing the mold using 3D printing or additive manufacturing techniques.

24. The method of claim 22, further comprising submersing the assembly in a cooling liquid.

25. A submersible communications interface assembly, comprising:
a transceiver having a transceiver connector;
a fiber optical cable having a fiber optical cable connector;
and a sealing material; and
wherein the transceiver connector is con pled to the fiber optical cable connector and the sealing material is configured to seal an interface between the transceiver connector and the fiber optical connector.

26. The communications interface assembly of claim 25, wherein sealing material is introduced into a mold to seal the interface between the transceiver connector and the fiber optical connector.
